(19) United States
(12) Patent Application Publication
(10) Pub. No.: US 2007/0152046 A1
(43) Pub. Date: Jul. 5, 2007

(54) Searchable or detectable tool or fastening member or the like

(76) Inventor: Chih-Ching Hsieh, Feng Yuan City (TW)

Correspondence Address: TROXELL LAW OFFICE PLLC;SUITE 1404, 5205 LEESBURG PIKE, FALLS CHURCH, VA, 22041, US

(21) Appl. No.: 11/324,384

(22) Filed: Jan. 4, 2006

(51) Int. Cl. G06Q 30/00; G06K 7/08

(52) U.S. Cl. 235/385; 235/451

(57) ABSTRACT

A searchable article such as a tool, an accessory of a tool, a fastening member or the like. An identification chip is mounted on the searchable article. The identification chip is able to emit an identification signal for a detector to identify. Therefore, the searchable article will emit a signal for easily judging whether the article is installed in a true position or locating the article.

### BACKGROUND OF THE INVENTION

The present invention is related to a tool, an accessory of a tool, a fastening member or the like, and more particularly to a searchable mechanical article which can be easily searched. Also, it can be easily judged whether the searchable article is installed in a true position. The article can be a tool or a fastening member such as a screw or a rivet.

There are various complicated and sophisticated apparatuses such as aircrafts, boats, power vehicles, etc. For example, an airplane engine includes numerous parts. In case any of these parts is not truly installed, for example, in case an important screw or gasket is not tightened in a specific position, the complicated apparatus may fail. The apparatus must be periodically maintained and the parts of the apparatus must be periodically replaced. When serviced, it is necessary to disassemble numerous parts and reassemble these parts. Therefore, it is quite time-consuming and laborious to maintain the complicated apparatus. In the case that any of the parts is incautiously not installed, the complicated apparatus may fail to result in danger. Therefore, it is quite important to install all the parts of aircrafts, boats, power vehicles, etc. in their true positions and no risk is allowed. However, it is very hard to ensure that every specific part of the complicated apparatus is truly installed and assembled.

Furthermore, the complicated apparatus is maintained or repaired in a large-size factory. The tools (such as wrenches, sockets, screwdrivers, etc.) and parts (such as screws, gaskets, etc.) are scattered around. Some tools or parts are easy to miss or hard to find. This leads to delay of service work. Also, when a worker goes back after leaving the working site, the worker often fails to find the necessary tools or parts.

Therefore, it is tried by the applicant to provide a measure enabling a worker to easily judge whether a specific part is truly installed and to quickly find a specific tool or part, especially with respect to a highly sophisticated apparatus requiring high security.

### SUMMARY OF THE INVENTION

It is therefore a primary object of the present invention to provide a searchable or detectable tool or fastening member or the like which can be easily found. Also, it can be easily judged whether the searchable tool or fastening member is installed in a true position.

The present invention can be best understood through the following description and accompanying drawings.

### BRIEF DESCRIPTION OF THE DRAWINGS

FIG. 1 is a perspective view of a first embodiment of the present invention;

FIG. 2 is a side partially sectional view of a second embodiment of the present invention;

FIG. 3 is a side partially sectional view of a third embodiment of the present invention;

FIG. 4 is a perspective view of a fourth embodiment of the present invention; and

FIG. 5 is a perspective view of a fifth embodiment of the present invention.

### DETAILED DESCRIPTION OF THE PREFERRED EMBODIMENTS

The searchable or detectable tool or fastening member or the like of the present invention can be a tool such as a wrench, a screwdriver and a pincers or an accessory of a tool, such as a socket or a fastening member such as a screw, a nut, a gasket and a rivet.

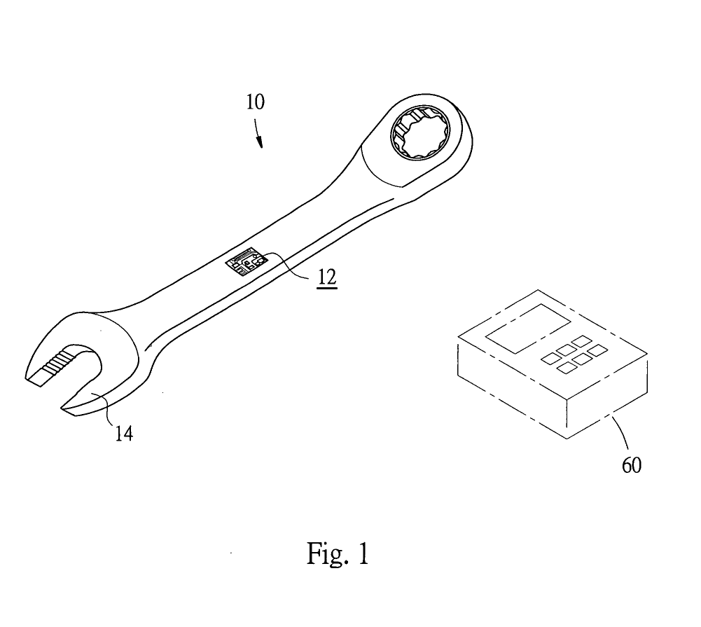

FIG. 1 shows a wrench 10 which is exemplified. An identification chip 12 is mounted on the wrench 10. The identification chip 12 can emit a signal which will be described hereinafter.

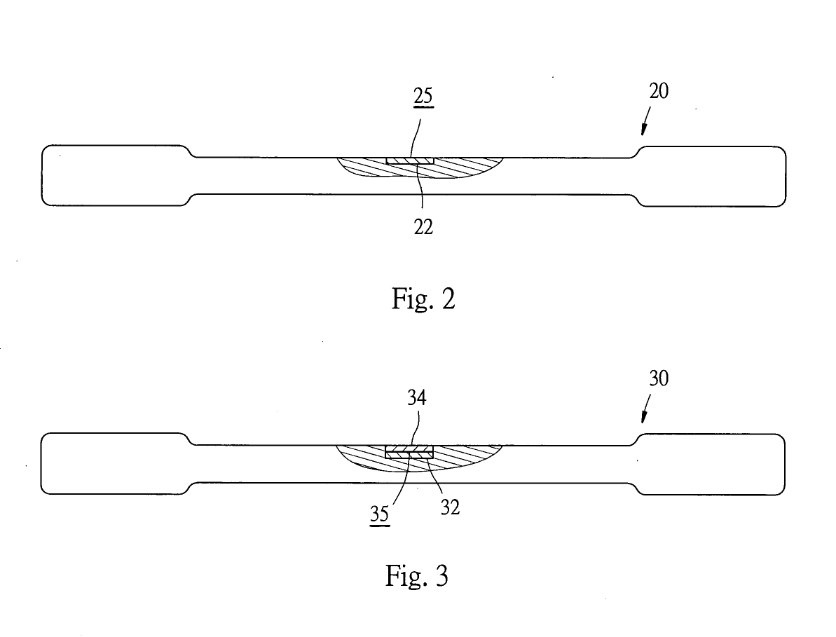

The identification chip 12 of the present invention is mounted on the wrench 10 in such a manner that the chip 12 is attached to the surface of the wrench 10. Alternatively, as shown in FIG. 2, the chip 25 can be embedded in a recess 22 of the wrench 20 and exposed to the surface of the wrench. Alternatively, as shown in FIG. 3, a chip 35 can be mounted in a recess 32 of the wrench 30 and a protective cover 34 is inlaid in the recess 32 to cover the chip 35. The chip 35 is powered by an inbuilt cell or solar cell or an externally connected cell, whereby the chip 35 can emit a signal such as small-power electromagnetic wave.

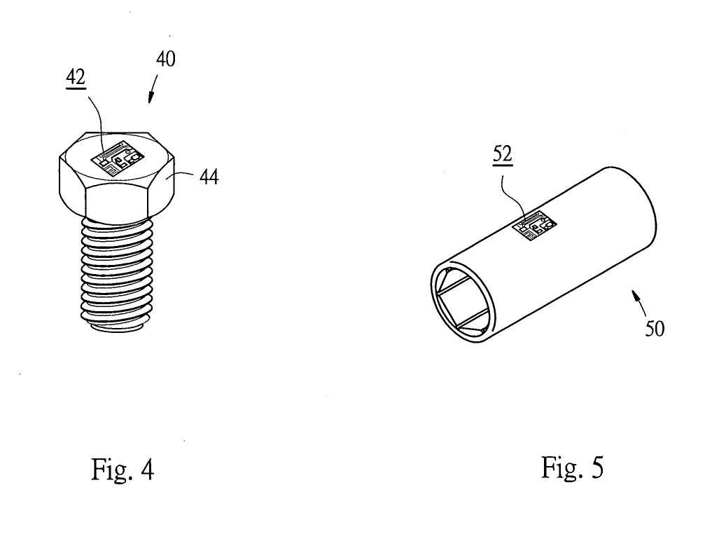

The subject of the present invention can be alternatively a screw 40 as shown in FIG. 4. An identification chip 42 is inlaid in the head section 44 of the screw 40. Alternatively, as shown in FIG. 5, an identification chip 52 can be mounted in a socket 50 to be searched.

The identification chip 12, 25, 35, 45 or 52 can emit a certain identification signal for a detector 60 to detect. Moreover, The chip can carry specific data according to the characteristics of the searchable article 10, 20, 30, 40 or 50. With the chip 12 mounted on the wrench 10 exemplified, the data of the chip 12 can clarify which kind of wrench the searchable article is. For example, the data can show that the wrench is a splined wrench or an open wrench. Also, the data can show the size of the holding section 14 of the wrench and the specific serial number of the searchable article. Similarly, in the case that the chip is mounted on a screw 40, the data of the chip can show the specification, model, length, serial number and even material of the screw. The detector 60 can read and show the data of the chip for identification. In other words, different articles equipped with the identification chips can emit different identification signals for easy identification.

It is easy to judge whether an important fastening member such as the screw 40 equipped with the identification chip is installed in a specific position. For example, with respect to a complicated sophisticated apparatus having numerous parts, after maintained or serviced, it is uneasy to ensure that a certain screw is installed. This is because the important screw is often tightened inside the apparatus and invisible. Conventionally, it is necessary to re-disassemble the apparatus for insurance. However, in the present invention, the important screw is equipped with the identification chip for emitting specific signal. By means of the detection device, the screw can be located to judge whether the screw is installed in the apparatus. Accordingly, it can be conveniently and precisely checked whether the important component is installed without consuming much time.

Moreover, in a large-size service site, when working on a large and complicated apparatus, it is uneasy to find an important part or tool among widely distributed parts and tools. However, according to the present invention, it is easy to detect and locate a specific part or tool equipped with the identification chip by means of a detector.

Different chips with different inbuilt serial numbers or data will emit different frequencies of signals for identifying different searchable articles.

According to the above arrangement, the present invention enables a user to judge whether a specific article is truly installed so as to ensure safety in use of a sophisticated apparatus. Also, a specific article can be quickly found and located.

The above embodiments are only used to illustrate the present invention, not intended to limit the scope thereof. Many modifications of the above embodiments can be made without departing from the spirit of the present invention.

What is claimed is:

1. A searchable or detectable tool or fastening member or the like comprising:
an article to be searched, such as a tool, an accessory of a tool or a fastening member, said tool or fastening member being characterized in that further comprising:
an identification chipmounted on the article to be searched, the identification chip being able to emit an identification signal, whereby the article to be searched will emit a signal for easily judging whether the article is installed in a true position or locating the article to be searched.

2. The tool or fastening member or the like as claimed in claim 1, wherein the identification signal includes data of the sort of the article to be searched.

3. The tool or fastening member or the like as claimed in claim 1, wherein the identification signal includes data of the serial number of the article to be searched.

4. The tool or fastening member or the like as claimed in claim 1, wherein the identification signal includes data of the material of the article to be searched.

5. The tool or fastening member or the like as claimed in claim 1, wherein the identification signal includes data of the size of the article to be searched.

6. The tool or fastening member or the like as claimed in claim 1, wherein the identification chip is disposed on a surface of the article to be searched.

7. The tool or fastening member or the like as claimed in claim 1, wherein a surface of the article to be searched is formed with a recess and the identification chip is inlaid in the recess.

8. The tool or fastening member or the like as claimed in claim 7, further comprising a protective cover inlaid in the recess to cover the identification chip.
